(19) United States
(12) Patent Application Publication
(10) Pub. No.: US 2005/0040809 A1
(43) Pub. Date: Feb. 24, 2005

(54) Power line property measurement devices and power line fault location methods, devices and systems

(76) Inventors: Arthur E. Uber III, Pittsburgh, PA (US); Bronwyn E. Uber, Pittsburgh, PA (US)

Correspondence Address: HENRY E. BARTONY, JR.;BARTONY & HARE, LLP, SUITE 1801, 429 FOURTH AVENUE, PITTSBURGH, PA, 15219, US

(21) Appl. No.: 10/922,397

(22) Filed: Aug. 20, 2004

Related U.S. Application Data
(60) Provisional application No. 60/497,108, filed on Aug. 22, 2003.

(51) Int. Cl. H05B 41/36

(52) U.S. Cl. 324/117 R

(57) ABSTRACT

A device for use in locating a fault on a power line of a power distribution system includes: at least one sensor for measuring at least one property of the power line, and at least one output device in operative connection with the sensor to signal a state of the power line. The signaled state of the power line is determined from the measured property and indicates whether a fault has occurred in the power line. The output device can, for example, signal a current state or a previous state of the power line. The device can further include a controller in operative connection with the output device to control the operation of the output device based upon at least one of the current state or the past state of the power line. A device for use in measuring a property of power line of a power distribution system includes: a connector adapted to place the device in operative connection with the power line in the power distribution system without taking the power line out of operation; a sensor for measuring a property of the power line, and an output device in operative connection with the sensor to transmit a signal representative of the measured property.

CROSS REFERENCE TO RELATED APPLICATION

This application claims benefit of the priority date of U.S. Provisional Patent Application Ser. No. 60/497,108, filed Aug. 22, 2003, the disclosure of which is incorporated herein by reference.

### FIELD OF THE INVENTION

The present invention relates to measurement devices for measurement of power line properties and to methods, devices and systems for determining the location of power line faults. The methods devices and systems of the present invention can, for example, be used by power distribution companies to aid their crews in more easily and quickly finding power line faults, and, as a result, better serve their customers.

### BACKGROUND OF THE INVENTION

Electricity is essential in all industrialized countries. It is used to power everything from small household appliances to large factories. To deliver electricity to each individual house, school, hospital or other building, a complex branching system or network of power lines can be found, usually overhead, throughout populated areas. These overhead power lines can be disrupted or knocked down by many things, for example in an ice storm, by a tree falling as a result of wind or lightening, or because of a vehicle hitting a utility pole. Because our convenience, livelihood, and sometimes even individual's lives are dependent upon electricity, this can lead to a dangerous or costly situation when many people are left without power for a significant length of time. When a wire breaks and falls to the ground, contacts an uninsulated part of the pole or another wire, or if a transformer, insulator or other piece of equipment fails, the surge of current to ground causes a circuit breaker to open. The circuit breaker usually tries to reset itself once or twice, and if it is unable to do so, it stays off until a repair crew drives to the location, searches for, finds, and repairs the fault. Power company systems can often indicate which circuit breakers at which substation are open. But finding the location of the fault between the substation and the buildings can be difficult because of the branching nature of power circuits and the remoteness and difficulty observing some runs of the power line.

Currently a power company needs to send out a truck with line repair personnel. Unless there is a call from a customer telling them exactly where the fault is located, they have to start from the power distribution substation and follow the wires out, looking for the fault, often through all hours of the night and/or during a storm. This is a very arduous task; all the while leaving customers without power. It is made more complicated because of the branching nature of residential power distribution system.

This was illustrated by a bad storm several years ago in the south Point Breeze section of Pittsburgh, Pa. A number of trees or large branches had been knocked down, some blocking streets. However, not every downed tree harmed the power lines, because in some areas the power lines are located in alleys or along the property line between houses, rather than along the streets. One of the inventors spent several hours helping a power company crew follow the lines looking for the fault. It was not until several hours later that the power company crew found the fault, fixed it, and was able to restore power to the neighborhood.

There is currently no way to easily retrofit a fault location device or system to an existing, operating power line.

### SUMMARY OF INVENTION

In one aspect, the present invention provides a device for use in locating a fault on a branch power line of a power distribution system including: at least one sensor for measuring at least one property of the power line, and at least one output device in operative connection with the sensor to signal a state of the power line. The signaled state of the power line is determined from the measured property and indicates whether a fault has occurred in the branch of the power line. The output device can, for example, signal a current state or a previous state of the power line. The device can further include a controller in operative connection with the output device to control the operation of the output device based upon at least one of the current state or the past state of the power line.

The signal of the output device can, for example, be sensed by a human. In one embodiment, the output device emits electromagnetic radiation. The electromagnetic radiation can be visible light. In another embodiment, the output device emits sound, which can be in the human audible range.

The device can further include at least one connector to position the device in sufficiently close proximity to the power line to enable the sensor to measure the property. In one embodiment, the connector is adapted to connect the device to a power line while the power line is in operation. The connector can, for example, place the device in operable connection with the power line via a non-conductive proximity relationship. The connector can alternatively place the device in operable connection with the power line via a non-conductive contacting relationship. The connector can alternatively place the device in operable connection with the power line via a conductive contacting relationship.

The device can further include a power source, wherein at least one of the sensor and the output device is in operative connection with at least one electrical circuit powered from the power source.

The sensor of the device can, for example, measure at least one of current, voltage, power, temperature, stress, vibration amplitude or vibration frequency. In one embodiment, the sensor measures current via a measurement of the magnetic filed caused by current in the power line. The sensor can, for example, be a Hall effect sensor.

In another aspect, the present invention provides a system for use in locating a fault in a power distribution system including: a plurality of indicator devices, wherein each of the indicator devices includes: at least one sensor for measuring at least one property of a power line in the power distribution system, and at least one output device in operative connection with the sensor to signal a state of the power line. As described above, the state is determined from the measured property and indicates whether a fault has occurred in the power line. The plurality of indicator devices are connected at different points in the power distribution system such that the signals of the output devices of the indicator devices enable tracing of the fault.

In another aspect, the present invention provides a device to measure at least one property of a power line of a power distribution system including: at least one sensor for measuring the property of the power line, at least one controller in operative connection with the sensor for at least periodically receiving a signal of the measure property from the sensor, at least one output device in operative connection with the controller to signal a state of the power line, wherein the state is determined from the measured property, and a power supply rechargeable from the power line to power the device.

In another aspect, the present invention provides a method of determining the location of a fault in a power distribution systems including: prior to the fault occurring, placing a plurality of devices in operable association with two or more branches of a power line of the power distribution system, wherein each device can determine if a fault current passed through the associated power line and can provide an indication if a fault current passed therethrough; subsequent to the occurrence of the fault, following the power line to the branch point, and following the power line from the branch point as indicated by the devices to have indicated the fault. The method can also include arriving at a subsequent branch point and following the power line from the subsequent branch point as indicated by the devices to have indicated the fault.

In still a further aspect, the present invention provides a device for use in measuring a property of a power line of a power distribution system including: a connector adapted to place the device in operative connection with the power line in the power distribution system without taking the power line out of operation; a sensor for measuring a property of the power line, and an output device in operative connection with the sensor to transmit a signal representative of (for example, proportional to) the measured property.

In several embodiments, the devices, systems, and methods of the present invention can quickly and efficiently guide power line repair personnel to the location of a fault. For example, a device of the present invention, which is in proximity to a power line, can indicate whether or not a surge current has passed through that power line just prior to the power being shut off. The device can also monitor and communicate other characteristics of the power line that would be beneficial to the power line company to know. Likewise, a set of devices of the present invention can be placed in proximity to a power line along the length of the power line to indicate the path taken by a surge current that passed through that section of the line just prior to the power being shut off. Moreover, one or more of the devices of the present invention can communicate with other similar devices or another device to aid in determining the fault location. The devices of the present invention can further provide an indication of whether a power line is currently powered to enhance the safety of power line workers.

The systems and devices of the present invention are relatively easy for power companies to install and to monitor. The sophistication of the monitoring systems can vary depending upon the power company's needs and willingness to invest in the system. The systems and devices of the present invention are also relatively simple to manufacture, distribute, and install at low costs.

### BRIEF DESCRIPTION OF THE DRAWINGS

Other aspects of the invention and their advantages will be discerned from the following detailed description when read in connection with the accompanying drawings, in which:

FIG. 1 illustrates a schematic representation of how electricity is distributed from a power substation to individual houses.

FIG. 2 illustrates a block diagram of an embodiment of the invention.

FIGS. 3 and 4 illustrate an outside view of an embodiment of the invention.

FIGS. 5, 6, and 10 illustrate details of an actual power line system.

FIG. 7 illustrates an embodiment of a sensor for use in the present invention.

FIG. 8 illustrates a graph of the behavior of the sensor of FIG. 7.

FIG. 9 illustrates a bridging wire between to power lines.

FIG. 11 illustrates a block diagram of another embodiment of the present invention.

### DETAILED DESCRIPTION OF THE INVENTION

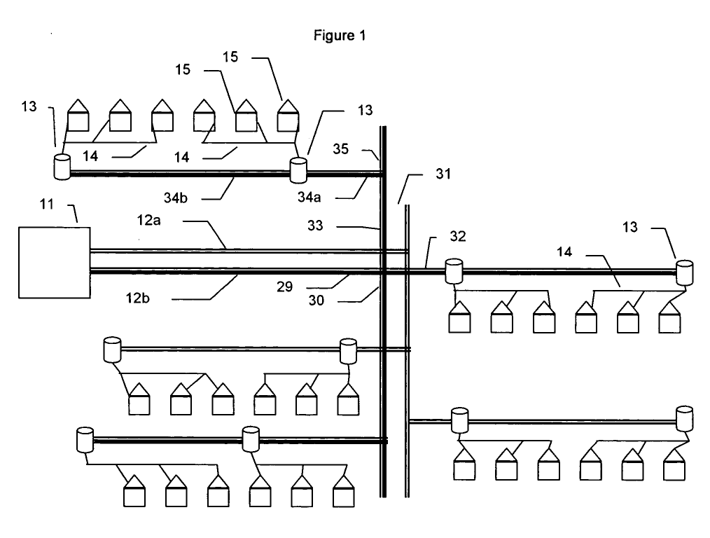

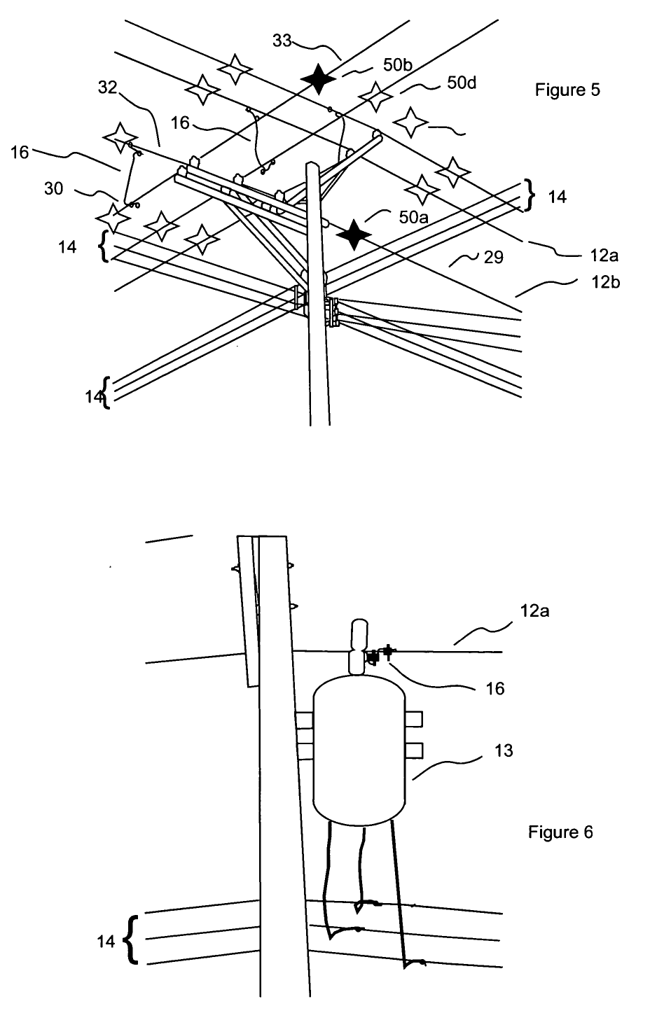

FIG. 1 is a simple schematic of a local power distribution grid showing how electricity is distributed from a power substation 11 to individual houses 15. The power substation 11 feeds two high voltage lines, 12a and 12b. The number of lines can vary. Three (3) is a common number because of the benefits of 3 phase AC power. The power substation contains circuit breakers that interrupt the flow of power to the high voltage lines 12a and 12b if the current drawn exceeds the capacity of the lines or other equipment. High voltage lines 12a and 12b can be on the order of 13,000 Volts (V) and carry currents of hundreds of amperes. These lines are on the very top of the power poles. They branch as needed and periodically are connected to step down transformers 13. These transformers reduce the voltage to +/−110 V for use in the home. The output of these transformers is usually 3 wires indicated as power line 14, a +110 V, a neutral, and a −110 V which run along the power poles below the high voltage line. Illustrative aspects of actual power line segments are show in FIGS. 5, 6, 9, and 10.

In regards to the high voltage lines, 12a and 12b, different line styles are used in the FIG. 1 to increase understanding, but the actual wires on the power pole are indistinguishable. This makes it very difficult to determine which wire branches at a specific point, making it even more difficult to follow a specific circuit and wire to check that there is no fault on it. Power lines 12a and 12b may have separate circuit breakers in the substation 11, or they can both be on one circuit breaker, in which case a fault on either line 12a or 12b will cause the breaker to open.

When a circuit breaker at a substation detects an over current condition and opens, it normally notifies the central power control station. Then after a short period of time, either automatically or through operator control, the circuit breaker is closed. If it stays closed, then it is assumed that the fault cleared itself and power is restored. This is done because there can be faults that are transient in nature, such as lightening induced currents or a branch or tree hitting a power line but not staying in contact with the power line and not breaking the line. Another source of a transient over current condition is if the falling tree severed the high voltage power line close to a pole in such a way that there was a fault to ground while the tree was in contact with line and falling, but once the tree fell and the wire was severed, there was then no fault to ground. In this case, the circuit breaker will close in the on state, and remain on, but houses served by the section of the power line downstream (from the substation) of the break will have no power.

If the circuit breaker detects a continuing over current condition after being restored, it trips or opens again. Sometimes there are additional reset attempts. After 2 attempts it is common to dispatch a crew to inspect the power lines 12a, 12b, and 14, manually clear or repair the fault, and report in when it is cleared. Then the circuit breaker can be reset and power is restored. The power company generally knows a starting point for the crew to search either because of communications from the substation or from the pattern of calls to the power company reporting individual power outages.

The challenge the power line crew faces is to find the fault through the many branchings of the power lines. Without an indicating device there is no way to discern the path taken by the overload or fault current. For example, as shown in FIG. 1, segment 29 branches into segments 30, 32, and 33. Likewise segment 33 branches into segments 34 and 35. Segment 34a denotes a portion of segment 34 before the first transformer 13 and segment 34b denoted the portion of segment 34 from the first transformer 13 to a second transformer 13.

FIG. 5 is an illustration of an actual crossing power line circuit. In this case there are three parallel lines. Bridging devices 16 couple power from the higher wires for example 29 to 32 to the lower wires, for example 30 to 33 that run perpendicular to the higher wires. FIG. 6 is a an illustration of a transformer 13 with a bridging connector 16 connecting it to high voltage power line such as 12a. The transformer's output is the set of 3 wires described above as power line 14. FIG. 10 is a an illustration of the power lines several hundred feet down the street from the crossover of FIG. 6, showing that power line 12a stops in this direction and power line 12b continues. This corresponds to point 31 in the diagram of FIG. 1.

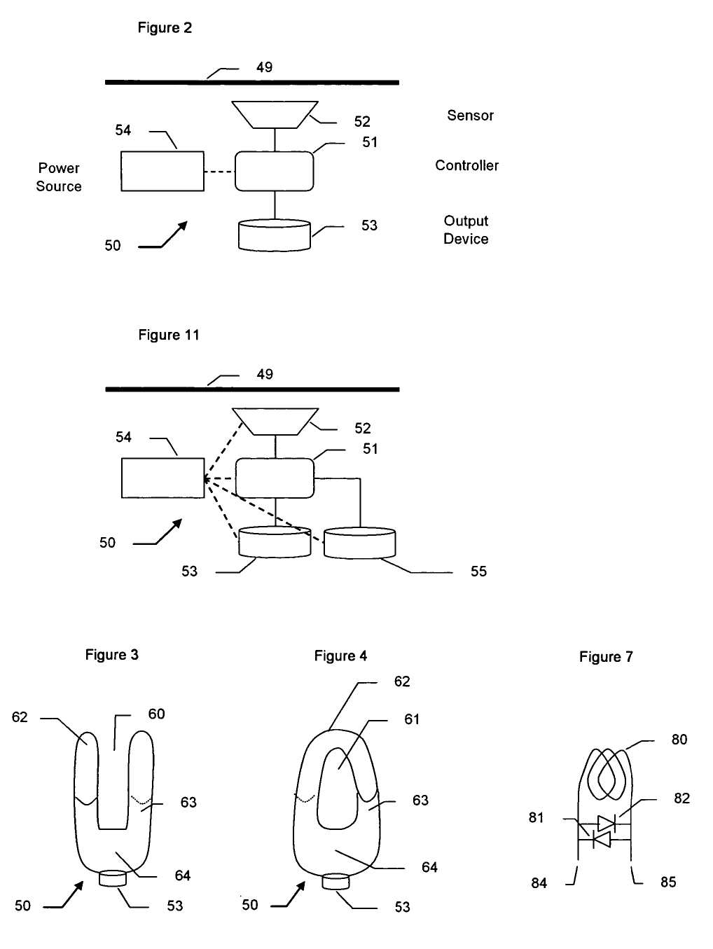

FIG. 2 shows a functional block diagram of the device 50 of the present invention. A sensor 52 measures one or more properties characteristic of the power line 49 with which it is in functional proximity. Examples of sensor 52 are a coil of wire, a magneto resistive sensor, and a hall effect transducer. All of these measure magnetic fields and thus can measure current in the power line 49. Exemplary magnetic field sensors are the A1321/2/3 family of ratiometric linear Hall effect sensors manufactured by Allegro MicroSystems, Inc., of Worcester, Mass. or the solid state Hall effect sensors—high performance miniature ratiometric linear SS490 series made by Honeywell of Freeport, Ill.

The output element 53 can indicate to a person, either directly or indirectly whether a fault current passed through the segment of the power line 49 that is being monitored. In one embodiment, output element 53 could be a red and a green emitting LED either in one package or packaged separately. The output element 53 could also be a device that changes color and is viewed via reflected light. More options are discussed below. Devices visible in reflected light have the benefit of being more viewable in daylight. Devices that emit light are better viewed in the dark. A single device 50 could include both types.

Controller 51 monitors the sensor 52 and determines when to activate one or any of several output devices 53 based upon the sensor input and a sequence of events in time. A series of activation states or sequences and options are discussed below. Controller 51 is preferably a microprocessor, although it can be partially or totally a mechanical device where some or all of the logic is carried out in mechanics rather than in electronics. Similar to how a mechanical circuit breaker works, an over current would trip the indicator device 50 and a “flag” would show. When the power comes back on with a current below the trip current, the flag would be retracted or reset so that it is no longer visible. If electronic, controller 51 is preferably a simple one chip microprocessor system such as are manufactured by a myriad of companies, but it can also be an analog or mixed circuitry device. Some or all of the circuitry can be embodied in a custom integrated circuit, which can significantly reduce the per piece cost of the electronics. These are among the many functional options useable by an electronic designer skilled in the art.

If the controller 51, sensor 52, or output element 53 incorporate electronic elements, then a source of electrical energy, power source 54, is needed. Power source 54 could be a coil, rectifier, and capacitor that taps power from the power line without conductive contact. If the power line indicator device 50 needs to operate when power line 49 is de-energized, power source 54 then needs to incorporate a battery, large capacitor, or other device for storing energy so that it can be released as electrical energy when the power line 49 power is off. Power source 54 could beneficially include a device to recharge the power storage device. This could be a coil and rectifier to pick up power from the power line 49, a solar cell, a thermoelectric energy source, or a device that generates energy from wind or other motion. With recent improvements in battery technology, lower power electronics, and LED efficiency, it might be possible to incorporate sufficient battery power in the power line indicator device 50 that it can last for its expected lifetime. Then no recharging capability is needed. This may reduce the initial cost and ensure that there are continued sales. It also forces the replacement of devices which otherwise could become old and fail without anyone knowing that they have failed. While power source 54 is shown connecting directly only to controller 51 in FIG. 2, it should be recognized that the power source can be directly connected to all or any of the electronic elements as needed.

FIGS. 3 and 4 are side and front external views of one embodiment of a power line indicator device 50. The device 50 can be generally thought of as 1.5 revolutions of a flattened or oval spiral or corkscrew, with a heavier bottom than top. When hanging on a power line, the two arms 62 and 63 hang on a power line 49 that goes through hole 61. To install the power line indicator device 50 onto a power line, it is held on the bottom by an insulated gripper and the power line is inserted all the way into the slot 60 shown in FIG. 3. With the arms 62 and 63 clearing the power line, the power line indicator device 50 is rotated 90 degrees so that the power line is passing though the bottom of hole 61. The indicator device 50 is then lowered so that it hangs on the power line and it is released from the gripper. The dimensions of the power line indicator device openings 60 and 61 and the length of the arms 62 and 63 can be adjusted for various cable sizes, or it be large enough to fit most cables. The arms could narrow toward the top of opening 61 so that they grip the power cable relatively tightly. They could also have a rubberized or friction enhancing texture to reduce the tendency of the indicator device 50 to slide down a line.

In one embodiment, the output device 53 is located on the outside of device 50 while the other components, sensor 52, controller 51, and optional power source 54 are located internally, preferably in section 64 where their weight ensures that the power line indicator device 50 hangs with the output device 53 pointing downward for easy viewing by a person on the ground. In another embodiment, the output device 53 can be internally located and when illuminated it makes the whole indicator device 50 glow. The power line indicator device 50 is preferably fully weather proof. One way to do this is to pot all the components inside an opaque epoxy, which makes a weatherproof seal with the case of the output device 53. Alternatively, some or all of the indicator device 50 could be translucent or clear so that the light from the output device 53 causes the indicator device 50 to “glow” as mentioned above. Then the output device 53 could be embedded inside the potting compound or case of the indicator device 50. The power line indicator device 50 could be insert molded or ultrasonically welded into a housing. Polycarbonate is a preferred injection molded housing material because of its toughness. There are also many options for the housing design. The housing could be similar to a clip clothespin that is manually opened or opens as the indicator device is pushed onto the power line and then has a spring which closes it and maintains its grip on the power line. The clothespin housing can, for example, be put into the end of an insulating pole that holds it in the open position. The open end of the clothespin can have a hook, so that when the power line indicator device 50 in place onto the wire, the insulating pole can be moved downward, releasing the clothespin and letting it close onto the power line. A different end arrangement on the insulating pole could hold and squeeze the ends of the clothespin, opening the gap and allowing removal from the wire. Alternatively the housing could use a spring-loaded latch of any type, such as a carabineer. Again, it could be manipulated via an insulating rod to place it on or off of the power line. The device similar to that disclosed in U.S. Pat. No. 5,729,872 can, for example, be used. A ratchet locks the capture mechanism in place. A ratchet locking cable tie type mechanism could also be used. Many of these have the benefit that there is a squeezing force by the power line indicator device 50 on the power line 49. This reduces the tendency for the indicator device to move along the length of the cable 49. In all these embodiments, one or more sensors 52, controllers 51, output devices 53 and optionally power sources 54 could be arranged so that they can be easily attached to or hung from a power line 49, and be readily viewed from the ground.

To prepare a power line to be monitored by a plurality of power line indicator devices 50, the power line indicator devices 50 are installed as described above at various points along long straight runs of power line such as segment 29 so that a crew can see from one to the next either with the unaided eye or with binoculars or night vision scopes. This is especially important if it is not possible for a power line crew to easily visualize or follow a power line as it crosses property away from roads or alleys. It is also important to install power line indicator devices 50 near or at a branch point such as power lines 30, 32, and 33 which branch from power line 29 in FIGS. 1 & 5 so that the crew knows whether to follow one branch or follow the other branch. Similarly, indicator devices 50 could beneficially be installed on the output of step down transformer 13 and the power line segment after the transformer, for example segment 34b. Although most low voltage power line runs 14 are relatively short in length, in rural areas, these may cross difficult terrain and thus could benefit from having periodic power line indicator devices 50 installed.

Before discussing operating modes, it is useful to discuss various power line characteristics and sensors 52 that can be used. Current conducted through the power lines was mentioned above. Current can be readily measured with Hall effect sensors or coils that measure the magnetic field caused by the current. Other magnetic field sensors may be used. A second characteristic that can be measured is voltage. Voltage can be measured capacitively, with two electrodes at different distances from the power line. The voltage between the two capacitively coupled electrodes depends upon the electric field between them. Alternatively the power line indicator device 50 may have a connection to ground or another reference, optionally a second indicator device 50, allowing it to measure voltage. This second indicator device 50 can be on a second power line, on the power pole, or a known distance from the power line and ground. There are other electric field and voltage sensing methods that also can be applied as one skilled in the art would know. In addition, other characteristics of the power lines, such as temperature, stress, and vibration amplitude or frequency could be measured and used in the operating algorithm, or just sensed and transmitted to the power company monitoring system. Temperature is a particularly useful one to monitor, because the overheating of a line or transformer could be an indication of line deterioration and could lead to line sagging. Fiber optic sensors may preferentially be used for all the above measurements. In this case, the sensor is all that needs to be in proximity to the power line and the other components of the indicator device 50 could be located some distance away, for example anywhere on the power line pole. In this embodiment, a single indicator device 50 may use one or more than one sensor 52. These sensors 52 may be in the same physical package, or may communicate their information to the controller through a hard wired (for example conductive wire or fiber optic link) or non-wired linkage (for example RF, IR, or sonic). Sensors 52 similar to or identical to those disclosed in U.S. Pat. Nos. 5,426,360 and 6,555,999 B1 can also be used in the present invention.

There are many operating modes or operational algorithms that can be employed in the indicator devices 50 of the present invention. One or more than one operating mode can be used at the same time. One is to have the power line indicator device 50 monitor the current passing through the line. The current will fluctuate as the loads (current demands) from the houses and building change over time. Turning on lights, refrigerators, heaters, or central air conditioning will increase the load. If power goes off, and there has been no current measured above a specific predetermined threshold, then the controller 51 activates the output device 53 and the indicator device 50 starts, for example, flashing green, with one flash every ten (10) seconds. If there has been a current above the predetermined threshold, then the controller 51 activates the output element 53 to, for example, flash red, with one flash every two (2) second. The number of flashes, each about ⅓ second apart, can, for example, indicate the number of times that the substation tried to close the circuit breaker and failed. The output element 53 continues flashing this way until power is restored, or if the battery starts running low on charge, it slows the rate down to conserve battery life. One reason for the different flash rates is to allow a person with red/green color blindness to notice the difference. An alternative is to use red and blue LEDs, although blue LEDs are currently more expensive.

Several benefits of the devices and system of the present invention are discussed below in connection with FIG. 5. The power line indicator device 50a on power line segment 29 is blinking red, indicated by its black color in the FIG. 5. This indicates that the fault current passed through that indicator device 50a. The only other one that is blinking red is indicator device 50b on segment 33. Indicator devices 50c, 50d, and the other indicator devices are flashing, indicated in FIG. 5 by their clear outline. The power line crew knows to follow segment 33 and does not need waste any time checking in any other directions. The power line crew can follow the indication of the fault path to the location of the fault. Without the red flashing indicator devices 50a and 50b, the power line crew would only have had a 33% chance of going the right way, and at each branching points the odds that they are going the right way to find the fault get lower and lower.

If power comes on briefly, but does not stay on, then the flashing is not stopped and the indicator device 50 is not reset. If it comes on for a predetermined length of time, for example 1 minute, then the flashing stops and the indicator device 50 returns to the monitoring state. Alternatively, it may be beneficial for the flashing to continue up to 12 hours, optionally at a lower repetition rate, in case there is a broken line down stream of the indicator device 50, but it was a self clearing fault, for example a broken line, that still requires efficiently guiding a repair crew to the location to repair the broken line.

One difficulty with the algorithm or mode of operation described above is that the controller 51 makes its decision based upon a predetermined fixed threshold. This means that there needs to be different indicator devices 50 for different capacity power lines. While simple to design and build, fixed threshold devices increased the inventor for the manufacturer and the power company, unless the threshold can be set at the time of installation. And the different indicator devices 50 need to be coded or readable as to their threshold setting.

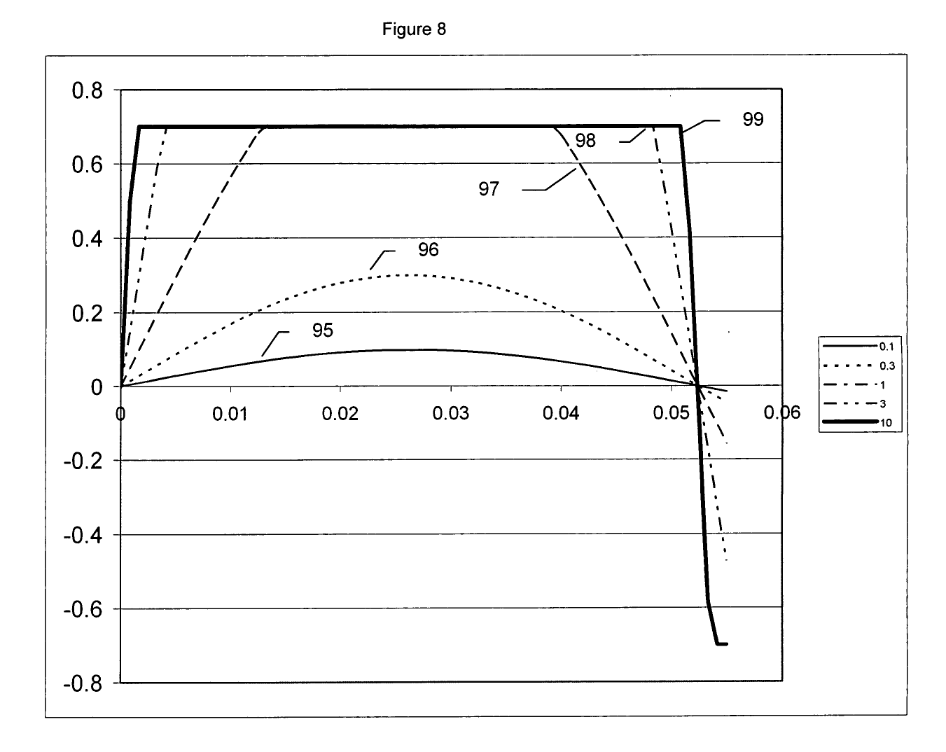

An alternative embodiment is to have the sensor 52 interface to the controller in a way that covers many orders of magnitude. An example of this is to have a logarithmic amplifier on the Hall effect sensor. A second option is to have a series of amplifiers with gains of, for example, 1, 8, 64, and 512. The controller 51 simply reads all the amplifiers'outputs, using the one that is not saturated or approximately zero. In this way, the sensor 52 and controller 51 can accommodate a wide range in the characteristic being sensed. Another alternative is to have the controller 51 or sensor 52 incorporate a variable or programmable gain and/or variable offset stage so that it can adjust itself either independently or as commanded by the controller 51, so that it can operate in the correct range for the power cable on which it is placed. Still another alternative is to have several sensors 52 which differ in their sensitivity, and the controller 51 utilizes the one that is operable under the conditions in which it finds itself. Having 3 coils, one with 100 turns around an area of 1 cm², a second coil with 1 turn and an area of 1 cm², and a third of 1 turn and an area of 1 mm² allows about 5 or 6 orders of magnitude of current to be sensed. Another approach is discussed in relation to FIGS. 7 and 8. FIG. 7 shows a coil 80 with diode snubbers or voltage limiters 81 and 82 and outputs or measurement points 84 and 85. If the coil 80 does not have sufficient internal resistance, then resistance can be added in series with the coil 80. FIG. 8 shows the voltage between measurement points 84 to 85 with different amplitudes of voltage induced by the magnetic field of the power line. For low fields, the amplitude of the waveform is a measure of current, curves 95 and 96. For high fields, the limiters 81 and 82 limit the amplitude of the voltage, but the rise or fall time is shorter the higher the magnetic field and thus the higher the induced voltage, as is shown in curves 97, 98, and 99. In this case, the rise time becomes a measure of the amplitude of the induced voltage, thus the magnetic field and thence the current in the power line. This allows measurement over a much wider dynamic range. It is reasonable to assume that 10 mV to 0.7 V amplitude can be easily measured. This gives a dynamic range of 70. If the amplitude can be measured down to 1mv, then the dynamic range is 700. Thereafter, the rise or fall time can be reasonably be measured from 10 millisecond down to 1 microsecond. This gives an additional dynamic range of 10,000.

In addition to having the controller 51 decide that a current is an overload based upon a fixed threshold as discussed above, the controller 51 could make the decision if the current increase by a prespecified percentage over the course of one or a few cycles of the 60 Hz power or a predetermined time if the power line is carrying DC current.

Another more flexible algorithm has the controller 51 self adjust the trigger threshold. When the indicator device 50 is put on or near a line 49, the controller sets the threshold to be a small or modest percentage above the current that it sees while the power stays on. Thus it sets its threshold based upon the “normal” current. If the current increases for several cycles but does not trip a circuit breaker, then the threshold is increased. It would be desirable for the controller 51 to use some time weighted average or other adaptive algorithm so that the threshold value can adjust downward as well as upward to normal usage patterns and still be sensitive to fault currents.

If the indicator device 50 has the ability to sense both current and voltage, then it can differentiate out of phase current from in phase current as well as the direction of power flow. This can be useful to help the indicator device 50 differentiate a surge of current flowing toward a fault to ground downstream from the indicator device 50 from a surge of current from one or more energy storage devices downstream of the indicator device 50 (motors or capacitor banks for phase adjustments are examples of such a device) that can send power back upstream over the grid to a fault to ground. For this approach, the indicator device preferably has two sensors 52, one that measures current and a second that measures voltage. The indicator device 50 now is orientation dependent so that it's mounting on the power line is important. For example, the indicator device could be designed so that leg 62 in FIG. 3 should be on the side of the power line closest to the substation 11 and leg 63 should be on the power line away from the substation. The controller 51 can then determine if the current is in phase with the voltage or out of phase with it, and whether the power is flowing toward the substation (and thus is coming from energy storage devices toward a fault) or is going from the substation and thus most likely toward the fault to ground.

The output device 53 can be one or several of many options. For human sensing or reading, it can be a simple light or light emitting diode that could vary in color and or flashing patterns depending on the fault conditions. It could emit IR light for viewing with night vision goggles. It could transmit data in Morse or some other code. It can be a liquid crystal display (LCD) or other display that can be seen with reflected or transmitted light. Any visible distinction between two or more states may be used, for example color, intensity, time pulsation, or position. The output device could have a dark disc or plate behind it so that there is more visible contrast when observed in daylight. Also, for use on power wires or lines 49 remote from roads, the output element 53 could point to one side to be viewed from the most readily accessible site or up for viewing by a helicopter. If the whole indicator device 50 glows as mentioned above, then it can be seen from all angles. The trade-off is that because the light leaves at all angles, it is not as bright at the most likely viewing angle. To overcome this, output element 53 could be bendable so it can be positioned just before or after it is installed on the power line 49.

Another human sensible output device 53 can employ sound in all its variations to alert a user. A challenge is that the ears cannot isolate the directionality of sound as well as the eyes can differentiate light, so it might be difficult to determine which of three indicator devices at the top of a pole is signaling, unless each had a distinctive sound, in tone or timing. A highly directional microphone could be used to determine which output device 53 is operating, and to detect the sound over a greater distance. The third remote human sense, smell could also be used, but it is even less directionally reliable than sound, being carried by the wind. The output element 53 could heat a fluid that gives off a smell or smoke. Alternatively, it could have a small electrochemical cell that generated hydrogen sulfide.

In other embodiments the output device can include output in segments of the electromagnetic spectrum or sonic spectrum that are not sensible to humans but can be sensed by electronic equipment. This has the benefit that a blinking red or green light on the power line will not alarm bystanders. This also has the benefit that more information can be encoded in the data stream. Examples with such desirable characteristics are infrared light or ultrasonic transmissions. These would be relatively near field communications methods, good for tens to hundreds of meters. Electromagnetic or radio waves, either transmitted directly through the air, as cell phone transmissions, or transmitted over the power line wires could also be the output of output element 53. These device to device communications could also employ light or sound that can be sensed by humans, but still encode data in a way that is not intelligible by humans. For example the LED could flash at a rate people cannot see and transmit via pulse code modulation or Morse code the current on the line while power is still running. This could be sensed and decoded by a device on the truck or held by a member of the power crew. This and similar embodiments give significant additional information to the power company that it cannot access except through very laborious means at this time.

In addition, the power line indicator device could include an input device 55 as shown in FIG. 11. This input device could receive various communications and the controller 51 would change state or act appropriately depending upon the communications it receives. More on this will be discussed later.

Given the capability for two way communications with an indicator device 50 or between two or more indicator devices 50, a significant range of possibilities is available. Each indicator device 50 or controller 51 could have a unique identifier. Each indicator device 50 or controller 51 could optionally have a real time clock and memory that enable it to record events or data and their time of occurrence for later transmission and analysis. If the indicator devices 50 can communicate to the central power company, and the central system knows where every indicator device 50 is located, then the central system can direct the field crew immediately to the segment where the fault has occurred. The location of the fault could thus be indicated on the computerized map of the streets and the power line in the crew's truck. If the indicator device 50 has both current and voltage measurement capability it could act as a power meter and load factor monitor for the associated power line. It could also act as a collector and repeater of remoter residential or commercial power meter reading.

In some of these embodiments, it is important that power always be supplied to a component or function, for example a volatile memory. In these cases, there may be several independent, separable, or somewhat independent power sources 54. If the output element 53 can deplete the stored energy and deprive the controller 51 of power, then the controller looses the ability to remember its state and threshold, which is not desirable. Alternatively, for memory, a non-volatile memory could be used. And, in some instances it is still desirable to have partitioned power sources, for example so that RF communications can be heard and made, even if visible communications cannot be.

These communications could be in reply to a query from a human or from the central base or at a time based upon the real time clock. They could be triggered by the occurrence of a fault. Alternatively, they could be ongoing from indicator device 50 to indicator device 50. This is similar to the networking that commonly occurs between computers in many situations today. There are many types and architectures of networks in use, for example hard wired, fiber optic, wireless RF, and wireless infrared. This could use the most basic and reliable protocols and strategies because the data rate can be very low. The X-10 communications protocol that is designed to allow central and remote control of remote devices over home wiring is one protocol that could be used. An indicator device 50 can wait to be polled, or it can communicate periodically. Well known collision avoidance or detection strategies can be utilized for these periodic communications. Techniques being developed by International Broadband Electric Communications of Huntsville, Ala. could also be used to transfer information from one indicator device 50 to another or to a control center. With any form of communications to a control center, the power line crew can be directed right to the indicator device 50 that is closest to the fault, saving time over having to manually follow the indicator devices 50 from the substation to the fault location.

When an indicator device 50 can communicate to another indicator device 50, especially if over the power line itself, they can continually be communicating with each other to make sure that there has not been a break on the line and that all the indicator devices 50 are functional. If there is a break, the transmission between adjacent or nearby indicator devices 50 will cease even if an overcurrent fault has not occurred. If indicator devices 50 were placed after each step down transformer 13, as well as at branching points, the communications between them could be used to indicate if a transformer overheats and its circuit breaker trips, or if it otherwise fails without causing a high current and tripping the upstream circuit breaker. The indicator device 50 located upstream of the open circuit would sense that it is missing transmissions from the adjacent down stream indicator devices 50 and relay this failure condition through the other upstream indicator devices 50 to the power substation or otherwise communicate it to the power company central office so that appropriate action could be taken to check and restore power to those downstream of the open circuit. Alternatively, the indicator devices 50 from the fault to the substation could then their output elements 53 to lead the power line crew to the location of the break in the line. If a single indicator device 50 fails, then it could mimic an open line, although the communications method can be chosen so that it is possible for the indicator devices 50 to communicate through one another so that several down the line can be “heard” if the line is not opened, whereas a number of indicator devices 50 would be “silenced” if a wire, circuit breaker or transformer were open.

With multiple indicator devices 50 communicating to each other, they could all be peers, having the same hierarchical position, or the selected ones could be masters and run a more sophisticated operating algorithm. Other information technology or network structures can be used, as are know to those skilled in that art.

The functions of the power line indicator device 50 described herein can be partitioned somewhat arbitrarily between the sensor 52, controller 51, output element 53, and input device 55. For example, scaling of measurements can be done in the sensor 52 with a digital number reported to the controller 51, or the sensor 51 can output one or more voltage waveforms as discussed in connection with FIG. 7, and controller 51 then includes an analog to digital converter that derives a digital number from the analog input. Similarly, sophisticated communications protocols such as those used in cell phones can be utilized fully within input element 55 and output element 53, or both of these may be embodied in a single electronic or integrated circuit. Multiple sensors 52, controllers 51, output elements 53, input elements 55, and even power sources 54 may be in single indicator device package or may be functionally linked even though in separate packages. One beneficial partitioning would be when there are several power lines 49 in parallel. There could be a sensor 52 for each line and just one controller 51 and one output device 53 where the output is coded to indicate which line has the fault. Various partitionings selected by designers skilled within the art are within the scope of this invention.

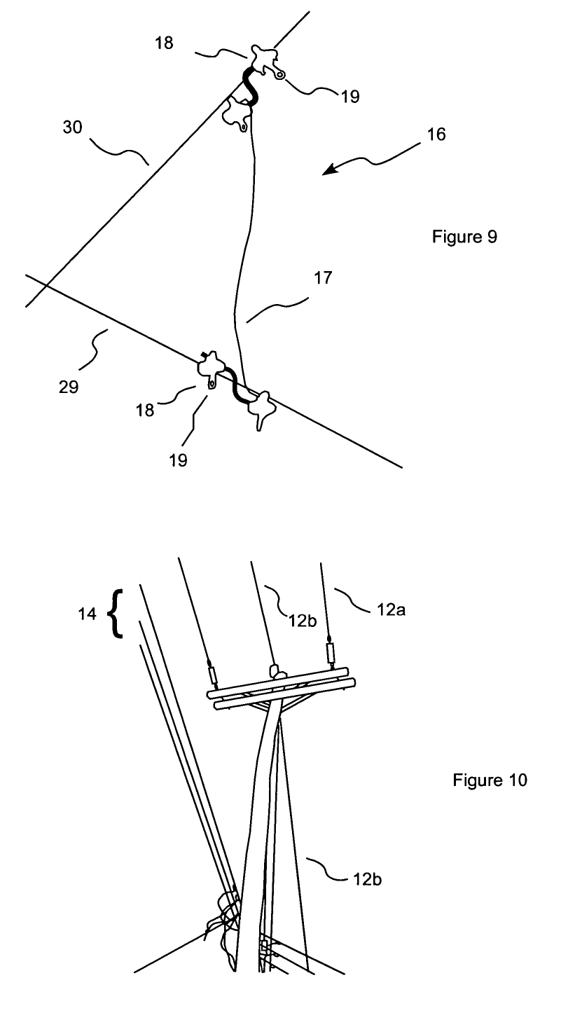

Likewise, a number of mounting options are described herein. The key is that the power line indicator device be close enough to measure the necessary characteristic and to indicate which power line to follow to the fault. The indicator device 50 can hang on the wire, be mounted or hang on the pole or other existing or new support in close proximity to the wire, be a part of a support insulator, be a part of a bridging connector 16 or be built into a bridging wire 17 or connector hardware 18 shown in FIG. 9, be built into a transformer, be incorporated in or onto anti-resonance mechanical devices used on long lengths of power line, or be built into the power line itself. Connector hardware 18 includes an attachment element such as a ring 19 which can be used to attach an extending rod (not shown) that can be used by a worker to safely maneuver connector hardware 18 in relation to a power line 30 to attach or remove connector hardware 18 from the power line 30. An indicator device 50 can beneficially be used at the end of a power line run to indicate if an open has occurred and optionally to indicate the number of reset attempts received, as mentioned elsewhere. Part of the output element 53 could be a fiber optic cable that is mounted on and runs some distance down the pole to be more easily seen from the ground. The indicator device 50 in some embodiments can make electrical contact with the power line or cable 49 to obtain more accurate information.

Because the power line 49 will move under the influences of wind and temperature, the power line indicator device 50 preferably needs to incorporate designs or strategies to avoid false signals caused by relative motion of the indicator device 50 and the power line 49. Some of the rigid mounting options described herein are sufficient. Also, the package designs that involve grabbing and holding the cable overcome this to a large degree. One way to improve all these designs is to incorporate a magnetic material either inside the case or use magnetic material loaded plastic for some of the case. This magnetic circuit conducts the magnetic field to the sensor in a way that makes it less susceptible to errors from relative motion between the power line 49 and indicator device 50. An exemplary current sensor with a magnetic circuit to make sensing independent of specific wire position is a CSLA1CD made by Honeywell of Freeport, Ill. It uses a magnetic material to conduct magnetic flux to a gap containing a Hall effect sensor.

The spring loaded or ratcheting closure styles of case are preferable for use with magnetic loaded plastics because the closure reduces the air gap in the magnetic circuit. One method of adjusting the sensitivity of a power line indicator device 50 is to place non-magnetic shims or pieces into the region of the magnetic path that closes as the power line is gripped. Widening the gap in the closed magnetic path reduces the sensitivity.

For the spiral power line indicator device 50 shown in FIGS. 3 and 4, additional stability can be achieved by having more turns, for example 2.5 instead of 1.5 mentioned above. Such an indicator device 50 could not be installed as discussed above, but could be installed by placing it adjacent to the line at a shallow angle and “screwing” it onto the line. Another strategy is to have the legs 62 and 63 be wide, extending into and out of the plane of the drawing in FIG. 4 so that the contact grove with the power line is lengthened. This would prevent twisting of the indicator device 50 in relation to the power line 49.

The embodiments above have been discussed in relation to outside, overhead power lines. Similar benefits would be gained by using them with in-ground power cables. These are not as likely to develop faults, however, when they do, it can be very difficult to identify the segment containing the fault. In this case, the power line indicator device 50 could be placed or buried in proximity or contact with the line, and a fiber optic or other output brought to the surface so that a crew can determine where the fault occurred that triggered the opening of the circuit. Or, indicator devices 50 could be placed in junction boxes. The power line indicator device 50 would also be helpful within a factory or other installation. Where there are external power lines, the application is identical to that described elsewhere herein. Within a building, while the distances are not as great, and the falling of trees is not likely, overloads can occur for other reasons. Similarly, these could be used in household wiring systems, even built into outlets, light switches, junction boxes or other components, to indicate which device triggered an overload. In a residential setting it is much more likely that it is the sum of several loads, each of which is below the limit for the circuit, caused an overload, however there is still value in identifying what caused the peak or increase that triggered the circuit breaker. The power line indicator devices 50 could lead to the offending outlet and this appliance—figuratively leading to finding the straw that broke the camels back. And these devices and methods can apply to DC as well as AC power. Hall effect sensors can measure DC magnetic fields. For example, one place they can have application is in large communications network centers where there is significant DC power distribution.

In addition to indicating faults and other uses mentioned above, the indicator devices 50 could improve safety for power line workers by indicating when a power line is electrified or has significant induced currents. To perform this function, the output device 53 could be continuously lit when power is sensed, or give a periodic chirping sound that can be hear when near to it.

Although the present invention has been described in detail in connection with the above embodiments and/or examples, it should be understood that such detail is illustrative and not restrictive, and that those skilled in the art can make variations without departing from the invention. The scope of the invention is indicated by the following claims rather than by the foregoing description. All changes and variations that come within the meaning and range of equivalency of the claims are to be embraced within their scope.

1. A device for use in locating a fault on a power line of a power distribution system, comprising:
at least one sensor for measuring at least one property of the power line, and
at least one output device in operative connection with the sensor to signal a state of the power line, the state being determined from the measured property, the signaled state indicating whether a fault has occurred in the power line.

2. The device of claim 1 wherein the output device signals a current state or a previous state of the power line.

3. The device of claim 2 further comprising a controller in operative connection with the output device to control the operation of the output device based upon at least one of the current state or the past state of the power line.

4. The device of claim 3 wherein said property is the current passing through the power line.

5. The device of claim 1 wherein the signal of the output device can be sensed by a human.

6. The device of claim 1 wherein the output device emits electromagnetic radiation.

7. The device of claim 6 wherein the electromagnetic radiation is visible light.

8. The device of claim 1 wherein the output device emits sound.

9. The device of claim 8 wherein the sound is in the human audible range.

10. The device of claim 1 further comprising at least one connector to position the device in sufficiently close proximity to the power line to enable the sensor to measure the property.

11. The device of claim 10 wherein the connector is adapted to connect the device to a power line while the power line is in operation.

12. The device of claim 11 wherein the connector places the device in operable connection with the power line via a non-conductive proximity relationship.

13. The device of claim 11 wherein the connector places the device in operable connection with the power line via a non-conductive contacting relationship.

14. The device of claim 11 wherein the connector places the device in operable connection with the power line via a conductive contacting relationship.

15. The device of claim 1 further comprising a power source, wherein at least one of the sensor and the output device is in operative connection with at least one electrical circuit powered from the power source.

16. The device of claim 3 further comprising a power source, wherein at least one of the sensor, the output device, and the controller is in operative connection with at least one electrical circuit powered from the power source.

17. The device of claim 1 wherein the sensor measures at least one of current, voltage, power, temperature, stress, vibration amplitude or vibration frequency.

18. The device of claim 1 wherein the sensor measure current via a measurement of the magnetic filed caused by current in the power line.

19. The device of claim 18 wherein the sensor is a Hall effect sensor.

20. The device of claim 1 wherein the device provides a signal indicating whether the power line is powered.

21. A system for use in locating a fault in a power distribution system, comprising:
a plurality of indicator devices, each of the indicator devices comprising:
at least one sensor for measuring at least one property of a power line in the power distribution system, and
at least one output device in operative connection with the sensor to signal a state of the power line, the state being determined from the measured property, the signaled state indicating whether a fault has occurred in the power line,
the plurality of indicator devices being connected at different points in the power distribution system such that the signals of the output devices of the indicator devices enable tracing of the fault.

22. The system of claim 21 wherein the at least two of the plurality of devices can communicate between each other.

23. A device to measure at least one property of a power line of a power distribution system, comprising:
at least one sensor for measuring the property of the power line,
at least one controller in operative connection with the sensor for at least periodically receiving a signal of the measure property from the sensor,
at least one output device in operative connection with the controller to signal a state of the power line, the state being determined from the measured property, and and a power supply rechargeable from the power line to power the device.

24. A method of determining the location of a fault in a power distribution systems, comprising:
prior to the fault occurring, placing a plurality of devices in operable association with two or more branches of a power line of the power distribution system, wherein each device can determine if a fault current passed through the associated power line and can provide an indication if a fault current passed therethrough;
subsequent to the occurrence of the fault, following the power line to the branch point, and following the power line from the branch point as indicated by the devices to have indicated the fault.

25. The method of claim 24 further comprising arriving at a subsequent branch point and following the power line from the subsequent branch point as indicated by the devices to have indicated the fault.

26. A device for use in measuring a property of power line of a power distribution system, comprising:
a connector adapted to place the device in operative connection with the power line in the power distribution system without taking the power line out of operation;
a sensor for measuring a property of the power line, and
an output device in operative connection with the sensor to transmit a signal representative of the measured property.
